(19) United States
(12) Patent Application Publication
(10) Pub. No.: US 2003/0075067 A1
(43) Pub. Date: Apr. 24, 2003

(54) Copying digital images from a removable memory to a peripheral device for processing

(76) Inventors: Donald J. Welch, Camas, WA (US); David M. Hall, Camas, WA (US); Stephen D. Dentel, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 09/981,832

(22) Filed: Oct. 18, 2001

(51) Int. Cl. B41C 1/00

(52) U.S. Cl. 101/483

(57) ABSTRACT

A peripheral device and method of processing digital images stored on a removable memory device that minimizes the downtime of the image acquisition device which generated the digital images. The device and method provide for copying the digital images from the memory device to the peripheral device before processing the digital images any further, thus freeing up the memory device for storing additional digital images.

### BACKGROUND OF THE INVENTION

As the availability of inexpensive photographic-quality printers as peripheral devices for computers has increased, there has also been an increase in the popularity of digital photography. Digital images can now be captured and printed with a quality that rivals those of traditional photographs. Many digital cameras capture photographic images at the push of a button, storing them electronically in the camera on a memory device such as a flash card. Some memory devices can store hundreds of digital images at a time. By uploading these digital images from the memory device to a computer, they can be efficiently stored on media such as writeable or rewriteable CD-ROMs. Since a memory device capable of storing a large number of digital images is relatively expensive but reusable, digital camera users typically use only one such memory device.

Some photographic-quality computer printers provide a convenient way of accessing digital images for printing and uploading by including a facility which receives the memory device after it is removed from the camera. During the time when the memory device is installed in the printer, some or all of the digital images can be selected, and the selected ones of the digital images can be printed on the printer's print mechanism and/or uploaded to the mass storage device of a computer which is attached to the printer.

Since a photographic-quality printing rate for an 8.5-by-11 inch page of digital images typically varies from several pages per minute to less than one page per minute, printing a large number of photos will take a considerable amount of time. The memory device must remain installed in the printer during the printing operations, and thus cannot be used for recording new images with the digital camera during that time. Adding in time delays for installing paper and/or ink supplies, and selecting the desired images for printing, only adds to the amount of camera downtime. Also, if the computer is not attached or operating, the digital images cannot be uploaded. It is only after the digital images have been printed and/or uploaded that they can be erased from the memory device to make room for the storage of additional digital images on the memory device.

Accordingly, it would be highly desirable to have a new and improved peripheral device and digital image access method that minimize the photographic downtime of a digital camera, or other image acquisition devices that record digital images on memory devices, due to the processing of digital images previously captured.

### SUMMARY OF THE INVENTION

In a preferred embodiment, the present invention provides a peripheral device that minimizes photographic downtime by copying the digital images from the memory device to the peripheral device before processing the digital images any further, thus freeing up the memory device for storing additional digital images. The peripheral device has a memory adapter adapted to receive the memory device, and a memory access subsystem coupled to the memory adapter which reads selected ones of the digital images from the memory device. Copies of the selected digital images are stored in an image storage subsystem. The digital image copies are retained for a time in the image storage subsystem after the memory device is removed from the memory adapter.

The present invention may also be implemented as a method of processing digital images stored on a removable memory device by an image acquisition device. The memory device is inserted into a memory adapter of a peripheral device, and at least some of the digital images from the memory device are copied to an image storage subsystem of the peripheral device so as to form digital image copies on the image storage subsystem. The memory device is then removed from the peripheral device prior to processing the digital image copies.

### BRIEF DESCRIPTION OF THE DRAWINGS

The above-mentioned features of the present invention and the manner of attaining them, and the invention itself, will be best understood by reference to the following detailed description of a preferred embodiment of the invention, taken in conjunction with the accompanying drawings, wherein:

FIG. 1 is a schematic representation of a system including a peripheral device according to a preferred embodiment of the present invention;

FIG. 2 is a block diagram of the system of FIG. 1; and

FIG. 3 is a flowchart of a method of processing digital images using the peripheral device of FIG. 1.

### DESCRIPTION OF THE PREFERRED EMBODIMENT

Referring now to the drawings, there is illustrated a peripheral device constructed in accordance with the present invention which minimizes the photographic downtime of an image acquisition device (such as a digital camera) due to the processing of digital images previously captured with the acquisition device and stored on a memory device. A memory access subsystem of the peripheral device provides access to the digital images stored on the memory device, and an image storage subsystem of the peripheral device provides a location to store copies of the digital images. In operation, the memory device is installed in a memory adapter of the peripheral device and some or all of the digital images are copied to the image storage subsystem. After the copying is completed, the images can be deleted from the memory device if desired, and the memory device can be removed from the memory adapter and returned to the image acquisition device.

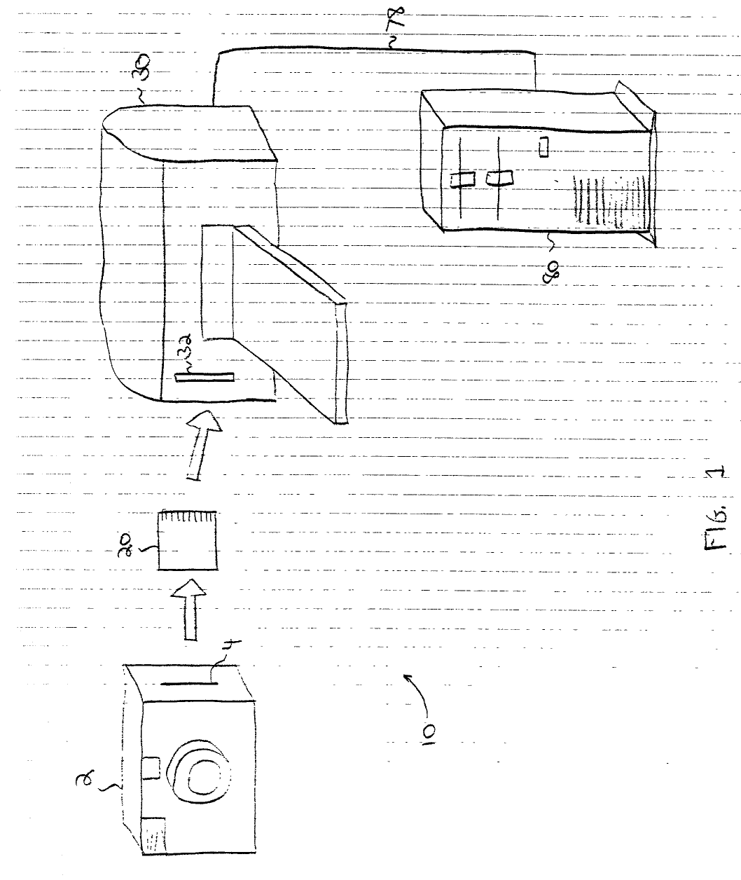

As best understood with reference to FIG. 1, a system 10 incorporating a preferred embodiment of the peripheral device 30 includes an image acquisition device 2 such as a digital camera which is adapted to receive a memory device 20. The image acquisition device 2 preferably has a slot 4 into which the memory device 20 is inserted during the capturing of photographic images by the image acquisition device 2. As known to those skilled in the art, a digital camera contains an imaging element (not shown) such as a CCD (charge-coupled device) sensor from which color and intensity information of an image projected onto a surface of the CCD by a lens arrangement can be digitally recorded to form a photographic image. The digital information which comprises the image is then stored on the memory device 20. Frequently the image acquisition device formats the digital image information according to the JPEG image file format or the TIFF image file format known in the art. The memory device 20 can preferably store a large number of such digital images at one time. When the memory device 20 is full, or at other times chosen by the user of the image acquisition device 2, the memory device 20 may be removed from the image acquisition device 2 and temporarily installed in a memory adapter 32 of the peripheral device 30 so that some or all of the digital images on the memory device 20 may be copied to and stored in the peripheral device 30, as will be discussed subsequently in further detail. In some embodiments, the system 10 may also include a computing apparatus 80 connected to the peripheral device 30 using a communications channel 78 which may be a serial, parallel, USB, IEEE 1394 “firewire”, network, or other channel known in the art. In such an embodiment, the digital images stored in the peripheral device 30 may also be uploaded to the computing apparatus 80 where they can be efficiently stored on storage media such as a hard drive or writeable/rewriteable CD-ROMs.

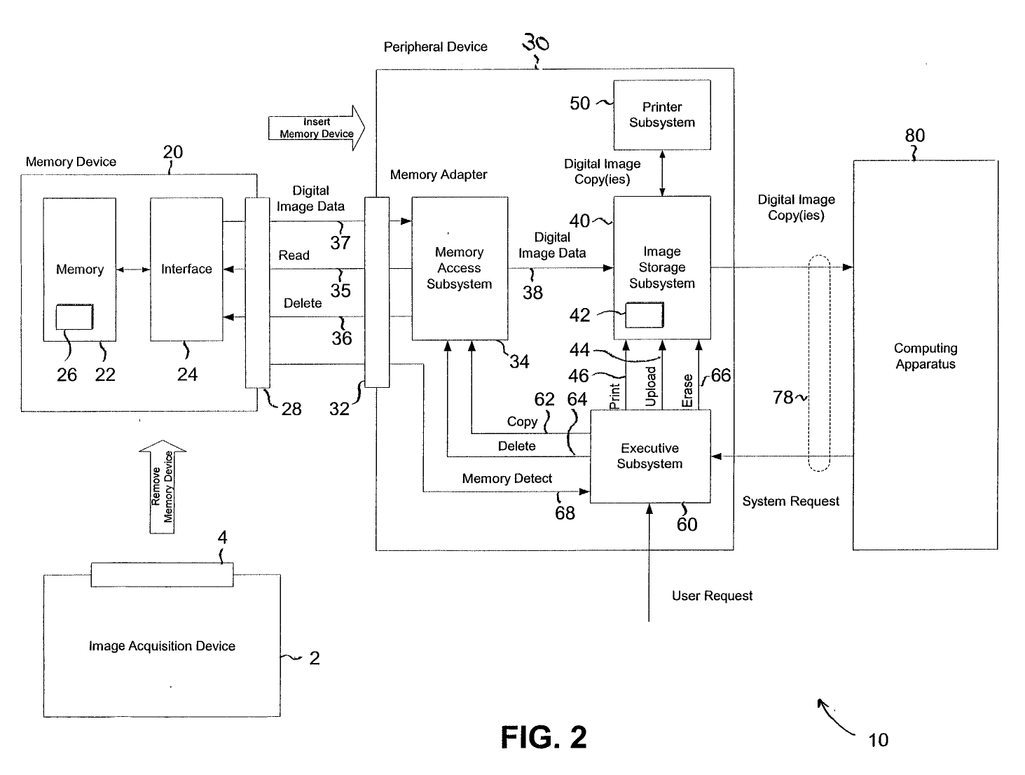

Considering now in further detail the memory device 20 of the system 10, and with reference to FIG. 2, the memory device 20 is preferably a SmartMedia (trademark of the Solid State Floppy Disk Card Forum) device, a Memory Stick (trademark of Sony) device, a CompactFlash (trademark of the CompactFlash Association) device, or the like. The memory device 20 includes a memory element 22 in which the data 26 representing the digital images are stored by the image acquisition device 2. The memory element 22 is preferably a non-volatile flash memory with a memory capacity in excess of four megabytes of image data. A memory element interface 24 provides access to the digital images in the memory element 22, including the ability to read the data representing selected ones of the digital images 26 from the memory device 20, and to erase or delete data representing selected ones of the digital images 26 from the memory device 20.

Considering now in further detail the peripheral device 30 of the system 10, and with continued reference to FIG. 2, a preferred embodiment of the peripheral device 30 includes a memory adapter 32, a memory access subsystem 34, and an image storage subsystem 40. The memory adapter 32 is designed to intermittently and temporarily receive the memory device 20 and communicatively couple the memory device 20 to the memory access subsystem 34. The memory adapter 32 typically is a connector which mates with a mating connector 28 of the memory device 20, and the coupling between the memory device 20 and the peripheral device 30 is typically a physical interconnection of electrical signal lines as known to those skilled in the art.

Considering now in further detail the memory access subsystem 34 of the peripheral device 30, and with continued reference to FIG. 2, the memory access subsystem 34 interoperates with the interface 24 to read the data for selected ones of the digital images 26 from the memory 22, and in some situations to delete this data from the memory 22. As will be discussed subsequently in greater detail, the memory access subsystem 34 receives requests to copy and delete digital image files 26 on the memory device 20. In response to these requests, the memory access subsystem 34 generates read 35 and delete 36 signals and sends them to the interface 24. These signals preferably also specify the particular ones of the digital images 26 which are associated with the requests; typically one or more images 26 are specified, but all images 26 contained on the memory device 20 may alternatively be specified. In response to a read signal 35, the interface 24 provides the data 37 for the specified digital images 26 to the memory access subsystem 34, which in turn provides image data 38 to the image storage subsystem 40 so that digital image copies 42 may be stored, as will be discussed below. In some embodiments, the memory access subsystem 34 may reformat the data 37 to form the data 38 in order to compensate for any differences between the file systems used by the memory device 20 and the peripheral device 30.

Considering now in further detail the image storage subsystem 40 of the peripheral device 30, and with continued reference to FIG. 2, the memory access subsystem 34 provides the data for the digital images 26 read from the memory device 20 to the image storage subsystem 40. The image storage subsystem 40 stores the data in an internal file system to form digital image copies 42 of the digital images 26. After the copies 42 of the desired digital images have been stored in the image storage subsystem 40, the digital images 26 may be deleted from the memory device 20, and/or the memory device 20 may be decoupled from the memory adapter 32 and returned to the image acquisition device 2 for use in capturing and storing new digital images.

The image storage subsystem 40 is coupleable to a computing apparatus 80 via a communications channel 78. In response to an upload signal 44, the data for selected ones of the digital image copies 42 are provided to the computing apparatus 80. Communications over the channel 78 between the peripheral device 30 and the computing apparatus 80 are preferably performed according to a standard protocol such as the Mass Storage Device Class (MSDC) specification, the PC Card ATA PCMCIA mass storage specification, the Auto-Indexing Mass Storage (AIMS) image and multimedia data file system specification, or the like.

Considering now in further detail a printer subsystem 50 of the peripheral device 30, and with continued reference to FIG. 2, the printer subsystem 50 is coupled to the image storage subsystem 40 so as to receive and print selected ones of the digital image copies 42 in response to a print signal 46 sent to the image storage subsystem 40. The printer subsystem 50 is preferably integral to the peripheral device 30, and produces photographic-quality images preferably using color inkjet technology.

Considering now in further detail an executive subsystem 60 of a preferred embodiment of the peripheral device 30, and with continued reference to FIG. 2, the executive subsystem 60 is coupled to the memory access subsystem 34 and the image storage subsystem 40 for orchestrating the operation of the peripheral device 30. The executive subsystem 60 receives user requests, typically from a user interface (not shown) of the peripheral device 30), and system requests from the computing apparatus 80 over the communications channel 78. A portion of each request preferably specifies the digital images 26 or copies 42 which are to be processed as per the request. Among the types of requests a preferred embodiment of the executive subsystem 60 orchestrates are a “copy” request to read selected ones of the digital images 26 from the memory device 20 and store corresponding digital image copies 42 on the image storage subsystem 40; a “delete” request to delete selected ones of the digital images 26 from the memory device 20; a “print” request to print selected ones of the digital image copies 42 on the printer subsystem 50; an “upload” request to upload selected ones of the digital image copies to the computing apparatus 80; and an “erase” request to erase selected ones of the digital image copies 42 from the image storage subsystem 40. The executive subsystem 60 generates signals 62, 64 (corresponding to the copy and delete requests respectively) and provides them to the memory access subsystem 34 for execution, and generates signals 46, 44, 66 (corresponding to the print, upload, and erase requests respectively) and provides them to the image storage subsystem 40 for execution. The executive subsystem also indicates (as part of signals 62, 64, 46, 44, 66) which ones of the images 26 or copies 42 are to be processed; typically, either selected ones or all the ones will be processed. If selected ones are to be processed, the executive subsystem 60 indicates to the memory access subsystem 34 or the image storage subsystem 40 which of the images 26 or copies 42 are to be processed.

In some embodiments, the executive subsystem 60 is further coupled to the memory adapter 32 so as to detect whether or not the memory device 20 is presently coupled to the memory adapter 32. A “memory detect”signal 68—preferably generated by a continuity connection between the memory device 20 and the memory adapter 32, or the like—is provided to the executive subsystem 60. By sampling the signal 68 at periodic intervals, the executive subsystem 60 can detect events such as the connection of the memory device 20 to, or its disconnection from, the memory adapter 32. In some embodiments, a connection event will automatically initiate a “copy” request to copy all digital images 26 to the image storage subsystem 40.

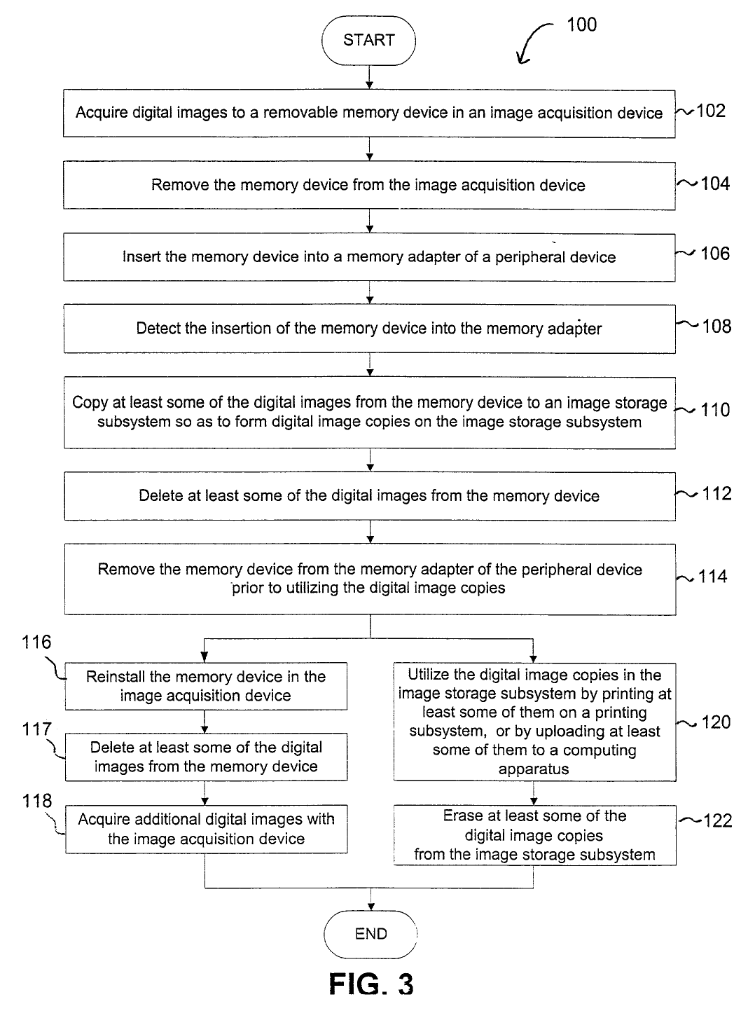

Another embodiment of the present invention, as best understood with reference to FIG. 3, is a method 100 for processing digital images 26 stored on a removable memory device 20 by an image acquisition device 2. The method 100 begins, at 102, by acquiring digital images 26 to a removable memory device 20 installed in an image acquisition device 2. At 104, the memory device 20 is removed from the image acquisition device 2. At 106, the memory device 20 is inserted into a memory adapter 32 of a peripheral device 30. At 108, the insertion of the memory device 20 into the memory adapter 32 is detected. At 110, at least some of the digital images 26 from the memory device 20 are copied to an image storage subsystem 40 so as to form digital image copies 42 on the image storage subsystem 40. At 112, in some embodiments, at least some of the digital images 26 are deleted from the memory device 20. At 114, the memory device 20 is removed from the memory adapter 32 of the peripheral device 30 prior to utilizing the digital image copies 42. At 116, the memory device 20 is reinstalled in the image acquisition device 2. At 117, in some embodiments, at least some others of the digital images 26 are deleted from the memory device 20. Note that deletion of digital images 26 may be done either at 112 or at 117, and is only required if insufficient space is available on the memory device 20 to store additional digital images 26. At 118, additional digital images 26 are acquired with the image acquisition device 2. Also after the removal at 114, and in parallel with 116-118, at 120 the digital image copies 42 in the image storage subsystem may be processed or utilized by printing at least some of the copies 42 on a printing subsystem 50 or by uploading at least some of the copies 42 to a computing apparatus 80. At 122, selected ones of the digital image copies 42 may be erased or deleted from the image storage subsystem 40 after they have been processed or utilized by the peripheral device 30.

From the foregoing it will be appreciated that the peripheral device and methods provided by the present invention represent a significant advance in the art. Although several specific embodiments of the invention have been described and illustrated, the invention is not limited to the specific methods, forms, or arrangements of parts so described and illustrated. In particular, while the present invention has been described with reference to images acquired by digital cameras, the invention is not limited to digital still cameras, but is applicable to any device that can store digital images, including digital camcorders, digital video players and/or recorders, and the like. Also, while the peripheral device has been described with reference to a printer, the invention is not limited to printers, but is applicable to other types of peripheral devices that can process digital images, such as digital projectors and the like. The invention is limited only by the claims.

What is claimed is:

1. A method of processing digital images stored on a removable memory device by an image acquisition device, comprising:
inserting the memory device into a memory adapter of a peripheral device;
copying at least some of the digital images from the memory device to an image storage subsystem of the peripheral device so as to form digital image copies; and
removing the memory device from the peripheral device prior to processing the digital image copies.

2. The method of claim 1, wherein the peripheral device includes a printing subsystem, and wherein the processing includes printing at least some of the digital image copies on the printing subsystem.

3. The method of claim 1, wherein the processing includes uploading at least some of the digital image copies to a computing apparatus communicatively coupled to the peripheral device.

4. The method of claim 1, further comprising:
deleting at least some of the digital images from the memory device after the copying.

5. The method of claim 1, further comprising:
reinstalling the memory device in the image acquisition device; and
acquiring additional digital images with the image acquisition device.

6. The method of claim 1, further comprising:
acquiring the digital images to the memory device with the image acquisition device; and
removing the memory device from the image acquisition device.

7. The method of claim 1, wherein the copying includes storing the digital image copies in a file system of the image storage subsystem.

8. The method of claim 1, further comprising
detecting the insertion of the memory device into the memory adapter; and
wherein the copying is initiated in response to the detecting.

9. The method of claim 1, wherein the at least some of the digital images includes all digital images on the memory device.

10. A peripheral device, comprising:
a memory adapter adapted to intermittently receive a memory device having digital images stored thereon;
a memory access subsystem coupled to the memory adapter so as to read selected ones of the digital images from the memory device; and
an image storage subsystem coupled to the memory access subsystem so as to store copies of the selected ones of the digital images after the memory device is removed from the memory adapter.

11. The peripheral device of claim 10, wherein the image storage subsystem further comprises a file system for storing the copies of the selected ones of the digital images.

12. The peripheral device of claim 10, wherein the memory device is a non-volatile flash memory device.

13. The peripheral device of claim 10, wherein the memory device has a memory capacity in excess of 4 megabytes of image data.

14. The peripheral device of claim 10, further comprising:
a printer subsystem coupled to the image storage subsystem which prints selected ones of the copies.

15. The peripheral device of claim 14, wherein the printer subsystem is integral to the peripheral device.

16. The peripheral device of claim 10, wherein the image storage subsystem is adapted to interface to a computing apparatus so as to upload selected ones of the copies thereto.

17. The peripheral device of claim 10, further comprising:
an executive subsystem coupled to the memory access subsystem and the image storage subsystem, the executive subsystem adapted to receive requests for performing image processing operations.

18. The peripheral device of claim 17, wherein the requests are selected from the group consisting of:
a copy request to read selected ones of the digital images from the memory device and store corresponding digital image copies on the image storage subsystem,
a delete request to delete selected ones of the digital images from the memory device,
a print request to print selected ones of the digital image copies on a printer subsystem,
an upload request to upload selected ones of the digital image copies to a computing apparatus communicatively coupled to the peripheral device, and
an erase request to erase selected ones of the digital image copies from the image storage subsystem.

19. The peripheral device of claim 17, wherein the executive subsystem is further coupled to the memory adapter so as to detect whether the memory device is received by the memory adapter.

20. The peripheral device of claim 10, wherein the memory access subsystem further deletes selected ones of the digital images from the memory device.

21. A method for processing digital images stored on a removable memory device by an image acquisition device, comprising:
a step for inserting the memory device into a memory adapter of a peripheral device;
a step for copying at least some of the digital images from the memory device to an image storage subsystem of the peripheral device so as to form digital image copies; and
a step for removing the memory device from the peripheral device prior to processing the digital image copies.

22. A peripheral device for processing digital images stored on a removable memory device, comprising:
means for inserting the memory device into a memory adapter of the peripheral device;
means for copying at least some of the digital images from the memory device to an image storage subsystem of the peripheral device so as to form digital image copies; and
means for removing the memory device from the peripheral device prior to processing the digital image copies.

23. A peripheral device, comprising:
a memory adapter for receiving a memory device having digital images stored thereon;
a memory access subsystem coupled to the memory adapter for reading selected ones of the digital images from the memory device; and
an image storage subsystem coupled to the memory access subsystem for storing copies of the selected ones of the digital images after the memory device is removed from the memory adapter.
